(19) United States
(12) Patent Application Publication
(10) Pub. No.: US 2017/0268300 A1
(43) Pub. Date: Sep. 21, 2017

(54) DRILLING TUBULAR WEIGHT COMPENSATING SYSTEM

(71) Applicant: MHWIRTH AS, KRISTIANSAND S (NO)

(72) Inventor: PER MORTEN LOEVSLAND, KRISTIANSAND (NO)

(73) Assignee: MHWIRTH AS, KRISTIANSAND S (NO)

(21) Appl. No.: 15/505,117

(22) PCT Filed: Jul. 8, 2015
(86) PCT No.: PCT/NO2015/050128

§ 371 Date: Feb. 20, 2017

(30) Foreign Application Priority Data
Aug. 21, 2014 (NO) 20141021

(51) Int. Cl. E21B 19/086; E21B 19/16; B66D 1/60

(52) U.S. Cl. CPC E21B 19/086; B66D 1/60; E21B 19/16; B66D 2700/026

(57) ABSTRACT

A positioning and compensation system for a tubular element to be connected to a drill string includes a gripping arm assembly with a gripping device which holds the tubular element in a position for connection to the drill string, and a load supporting and compensating arrangement which supports at least a portion of a load of the tubular element. The load supporting and compensating arrangement includes a cylinder unit having a piston, a winch, a sheave which is connected to the gripping arm assembly, and a wire. The wire is arranged to run around the sheave with a first end being connected to the piston and a second end being connected to the winch. The winch and the cylinder unit are each arranged in a respective elevated position compared to a position of the sheave. The cylinder unit maintains a minimum tension in the wire.

### CROSS REFERENCE TO PRIOR APPLICATIONS

This application is a U.S. National Phase application under 35 U.S.C. §371 of International Application No. PCT/NO2015/050128, filed on Jul. 8, 2015 and which claims benefit to Norwegian Patent Application No. 20141021, filed on Aug. 21, 2014. The International Application was published in English on Feb. 25, 2016 as WO 2016/028157 A1 under PCT Article 21(2).

### FIELD

The present invention relates to a positioning and compensation system for a tubular element to be connected to a drill string and to a method for supporting at least a portion of the load of a tubular element to be connected to a drill string.

### BACKGROUND

When assembling a pipe string, such as a drill string, a completion string, or other well related equipment, care needs to be taken when carrying out the steps of joining a tubular element such as, for example, a pipe element, to the existing pipe string. Because the pipe elements to be joined with the drill string may have a considerable weight, special care needs to be taken when transferring the weight of the pipe element to the drill string so that the end joints, such as, for example, threads making up a screw joint, are not damaged when establishing contact between the pipe element and the existing drill string.

This problem is well known within the technical field. Several attempts have been made to provide solutions to set off the weight of the pipe element to be joined with the pipe string in order to save the end joints when connecting the pipe element and the pipe string.

The following documents disclose relevant prior art solutions:

US 2013/0146304 describes an arrangement for compensating the weight of a tubular element. A tubular compensator is provided to carry the tubular element to be connected with the completion string. The tubular compensator comprises roller assemblies. The roller assemblies are vertically adjusted by pressure controlled pistons in accordance with the force applied by the tubular element to counterbalance the weight of the tubular elements to save the threads in the connection between the tubular element and the completion string. The tubular compensator is hoisted by the travelling block for positioning the tubular element before coupling with the tubular string.

EP 142477 describes a telescoping arm arrangement to position a pipe element onto a drill string. A grab head is articulated to the telescoping arm to hold the pipe element, and a cylinder is provided to rotate one of the telescoping arm arrangements. The cylinder may also be used as weight compensating means for a pipe element to be connected to the drill string.

Because most prior art solutions are complex assemblies which occupy a relatively large space, a need has developed within the field for providing a simple solution which is easy to operate and maintain, and which occupies a relatively small space.

### SUMMARY

An aspect of the present invention is to provide an improved system for positioning the pipe element for connection with the pipe string while at the same protecting the threads during connection and disconnection. A further aspect of the present invention is to provide a system made up of simple and reliable components.

In an embodiment, the present invention provides a positioning and compensation system for a tubular element to be connected to a drill string which includes a gripping arm assembly comprising a gripping device which is configured to hold the tubular element in a position for connection to the drill string, and a load supporting and compensating arrangement configured to support at least a portion of a load of the tubular element. The load supporting and compensating arrangement comprises at least one cylinder unit comprising a piston, at least one winch, at least one sheave which is connected to the gripping arm assembly, and at least one wire comprising a first end and a second end. The at least one wire is configured so that the first end is connected to the piston, the at least one wire runs around the at least one sheave, and the second end is connected to the at least one winch. The at least one winch and the at least one cylinder unit are each arranged in a respective elevated position compared to a position of the at least one sheave. The at least one cylinder unit is configured to maintain a minimum tension in the at least one wire.

### BRIEF DESCRIPTION OF THE DRAWINGS

The present invention is described in greater detail below on the basis of embodiments and of the drawing in which:

FIG. 1 is a diagrammatic view of an example of arrangement of the present invention.

### DETAILED DESCRIPTION

The present invention provides a simple solution by utilizing components such as a sheave, wire, and a small cylinder unit which makes up a relatively small sized arrangement.

The system in accordance with the present invention provides several advantages compared to prior art solutions. The present invention provides a low frictional system which is also compact.

The system of the present invention utilizes a cylinder unit with a piston which operates in tension, thereby providing the radial forces of the cylinder unit which are negligible. The need for dimensioning against cracking of the piston rod is therefore low. Because the system includes the use of a wire and a sheave, the cylinder unit included in the arrangement of the present invention may be small and the friction of the cylinder unit is therefore also less than for a relatively large sized cylinder unit such as the one used in the arrangement described in US 2013/04166304.

The cylinder unit included in the system of the present invention allows for leakage over the piston. The requirement relating to the tightness/sealing effect of the sealing elements are therefore low. The sealing elements may thus be provided with a low friction and thus contribute little to the total friction of the system.

The sheave(s) to be included in the system of the present invention may also have a large dimension, which provides a small contribution to the total friction.

The cylinder unit has a cylinder housing for accommodating the piston. The cylinder housing is provided so that the piston does not reach its end stop to avoid jamming of the piston and to provide that the piston area is constant over the entire piston stroke. This implies that the force deliverance remains constant. The cylinder housing also takes up maximal wire tension forces when the system is not in operation.

The present invention provides a positioning and compensation system for a tubular element to be connected to a drill string. The positioning and compensation system comprises a gripping arm assembly arranged with a gripping device to hold the tubular element in a position for connection to the drill string. The positioning and compensation system also comprises a load supporting and compensating arrangement to support at least a portion of the load of the tubular element. The load supporting and compensating arrangement may comprise at least one cylinder unit, at least one winch, at least one sheave, and at least one wire. The at least one wire may have one end connected to a piston of the at least cylinder unit, the wire running around the at least one sheave and having the other end connected to the at least one winch. The at least one sheave is connected to the gripping arm assembly, and the at least one winch and the at least one cylinder unit are arranged in elevated positions compared to the position of the at least one sheave. The load supporting and compensating arrangement may be configured so that the activation of the at least one cylinder unit maintains a minimum tension in the wire when a measured tension of the wire deviates from a preset tension.

In an embodiment of the positioning and compensation system of the present invention, the cylinder unit can, for example, have a piston which is movably arranged for the activation of the at least one cylinder unit. The regulation of the fluid pressure in the cylinder unit may control the movement of the piston.

In a position where contact is established between the pipe element and the drill string and the tension of the wire is below a preset tension, the piston can, for example, be arranged to move into a position away from the sheave to maintain a minimum tension in the wire.

The wire may be tensioned by the winch in preparation for the at least cylinder unit to carry out a compensation stroke when connecting the pipe element to the drill string.

The piston may be arranged for movement into a position closer to the sheave for carrying out the compensation stroke during the connection of the pipe element to the drill string.

The support structure may be a vertical extending structure, wherein the at least one winch and the at least one cylinder unit are arranged at an end portion of the support structure, and the at least one sheave is arranged distanced below the at least one winch and the at least one compensating cylinder unit.

The present invention also relates to a method for supporting at least a portion of the load of a tubular element to be connected to a drill string by the use of a positioning and compensation system as described above, wherein the method comprises the following steps:
measuring the tension of the wire;
comparing the measured tension of the wire to a preset tension value and, if the measured tension deviates from the preset tension value;
activating the cylinder unit in order to maintain a minimum tension in the wire.

In an embodiment, the method of the present invention includes activating the at least one cylinder unit in order to maintain a minimum tension in the wire and moving the piston in a direction away from the sheave.

The tubular element can, for example, be positioned to be in contact with the drill string, thereby causing the tension of the wire to drop below a preset tension. In response to this drop of tension, the piston is moved in a direction away from the sheave to reestablish/maintain a minimum tension in the wire.

The wire may be tensioned by the winch to prepare the cylinder unit to carry out a compensation stroke.

In an embodiment, the method of the present invention comprises connecting the tubular element to the drill string, and carrying out the compensation stroke by moving the piston in a direction toward the sheave.

The winch may be at rest during the connection of the tubular element to the drill string.

These and other characteristics of the present invention will be explained in more detail below under reference to the attached drawing showing.

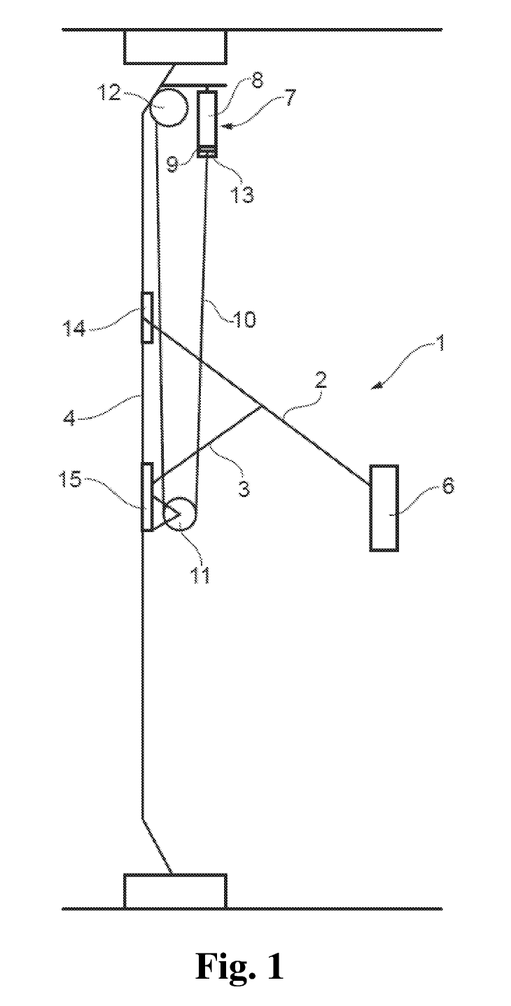

FIG. 1 shows a gripping arm assembly 1 comprising a first gripping arm 2 and a second gripping arm 3. The first gripping arm 2 is attached to a vertical extending structure 4 by a first connecting element 14. The vertical extending structure 4 is shown as a column in FIG. 1. A gripping device 6, which is provided for accommodation and holding of a pipe element (not shown in the drawing) to be connected with a pipe string (not shown in the drawing) is arranged at the other end of the first gripping arm 2. One end of the second gripping arm 3 is attached to the vertical extending structure 4 by a second connecting element 15, and the other end of the second gripping arm 3 is connected to the first gripping arm 2.

A positioning and compensation system is provided to support at least a portion of the weight of the pipe element carried by the gripping device 6. The support of the pipe positioning and compensation system is provided by a load supporting and compensating arrangement comprising a cylinder unit 7, a wire 10, a sheave 11, and a winch 12. The cylinder unit 7 comprises a cylinder housing 8 with a movable piston 9 arranged in the cylinder housing 8. The pressure of the fluid working on a working piston area 13 of the movable piston 9 provides a force which balances at least a portion of the force working on the gripping element 6 due to the weight of the pipe element. The wire 10 is connected to the movable piston 9 and runs around the sheave 11 in a loop to connect into the winch 12. In the shown embodiment, the winch 12 and the cylinder unit 7 are located elevated at an upper end portion of the vertical extending structure 4, and the sheave 11 is located below the winch 12 and the cylinder unit 7. In the shown embodiment, the control and regulation of the pressure of the cylinder unit 7 provides that a minimum tension is provided in the wire, thereby balancing at least a portion of the weight of the pipe element. The load supporting and compensating arrangement is especially useful when connecting the pipe element to an existing pipe string to protect the threads from damage by reducing the weight impact from the pipe element onto the existing pipe string, and also to avoid pull forces during spin in/out sequences.

The load supporting and compensating arrangement is provided so that, if the tension of the wire deviates from a preset tension in the wire, the piston 9 is arranged to move in the cylinder housing 8, thereby providing that a minimum wire tension is maintained in the wire 10. This working of the load supporting and compensating arrangement may occur as a result of offsetting the pipe element onto the pipe string. The set off of the pipe element onto the pipe string reduces the tension of the wire 10, and the control system of the arrangement is provided so that if the measured tension in the wire is below a preset tension, the piston 9 is moved in the in the cylinder housing 8 in the direction away from the sheave 11, thereby maintaining the minimum wire tension.

To prepare for the connection of the pipe element to the pipe string (the spin-in operation), the winch 12 will retract in order to prepare the cylinder unit 7 for carrying out a sufficient compensation stroke during the spin-in operation. The winch 12 does not move during the spin-in operation, but the piston of the cylinder unit 7 will provide a sufficient compensation stroke during the spin-in operation to support at least a portion of the weight of the pipe element. When carrying out the compensation stroke, the piston moves in the cylinder housing towards the sheave 11. Pull forces during spin in and spin out sequences are avoided because the necessary tension or the minimum tension of the wire 10 is provided by the compensation stroke of the cylinder unit 7 instead of using the winch 12.

The present invention is not limited to embodiments described herein; reference should be had to the appended claims.

What is claimed is:

1-14. (canceled)

15. A positioning and compensation system for a tubular element to be connected to a drill string, the positioning and compensation system comprising:
a gripping arm assembly comprising a gripping device which is configured to hold the tubular element in a position for connection to the drill string; and
a load supporting and compensating arrangement configured to support at least a portion of a load of the tubular element, the load supporting and compensating arrangement comprising:
at least one cylinder unit comprising a piston,
at least one winch,
at least one sheave which is connected to the gripping arm assembly, and
at least one wire comprising a first end and a second end, the at least one wire being configured so that the first end is connected to the piston, the at least one wire runs around the at least one sheave, and the second end is connected to the at least one winch,
wherein,
the at least one winch and the at least one cylinder unit are each arranged in a respective elevated position compared to a position of the at least one sheave, and
the at least one cylinder unit is configured to maintain a minimum tension in the at least one wire.

16. The positioning and compensation system as recited in claim 15, wherein the load supporting and compensating arrangement is further configured to activate the at least one cylinder unit to maintain the minimum tension in the at least one wire when a measured tension of the at least one wire deviates from a pre-set tension.

17. The positioning and compensation system as recited in claim 15, wherein the piston of at least one cylinder unit is configured so that a movement of the piston activates the at least one cylinder unit.

18. The positioning and compensation system as recited in claim 17, wherein the movement of the piston is controlled via a regulation of a fluid pressure in the at least one cylinder unit.

19. The positioning and compensation system as recited in claim 15, wherein,
in a position where a contact is established between a pipe element and the drill string and,
a tension of the at least one wire is below a pre-set tension,
the piston is arranged to move into a position away from the at least one sheave 11 so as to maintain the minimum tension in the at least one wire.

20. The positioning and compensation system as recited in claim 15, wherein the at least one wire is tensioned by the at least one winch in preparation for the at least cylinder unit carrying out a compensation stroke when connecting a pipe element to the drill string.

21. The positioning and compensation system as recited in claim 20, wherein the piston is configured to move into a position which is closer to the at least one sheave to carry out the compensation stroke when connecting the pipe element to the drill string.

22. The positioning and compensation system as recited in claim 15, further comprising:
a vertical extending structure comprising an end portion,
wherein,
the at least one winch and the at least one cylinder unit are each arranged at the end portion of the vertical extending structure, and
the at least one sheave is arranged below the at least one winch and the at least one compensating cylinder unit.

23. A method for supporting at least a portion of a load of a tubular element to be connected to a drill string, wherein,
a gripping arm assembly comprising a gripping device which is configured to hold the tubular element in a position for connection to the drill string, and
a load supporting and compensating arrangement configured to support at least a portion of a load of the tubular element, the load supporting and compensating arrangement comprising:
at least one cylinder unit comprising a piston,
at least one winch,
at least one sheave which is connected to the gripping arm assembly, and
at least one wire comprising a first end and a second end, the at least one wire being configured so that the first end is connected to the piston, the at least one wire runs around the at least one sheave, and the second end is connected to the at least one winch,
wherein,
the at least one winch and the at least one cylinder unit are each arranged in a respective elevated position compared to a position of the at least one sheave, and
the at least one cylinder unit is configured to maintain a minimum tension in the at least one wire,
are each provided, and
the method comprises:
measuring a tension of the at least one wire;
comparing the measured tension of the at least one wire to a preset tension value, and, if the measured tension of the at least one wire deviates from the preset tension value,
activating the at least one cylinder unit so as to maintain the minimum tension in the at least one wire.

24. The method as recited in claim 23, wherein the activating of the at least one cylinder unit so as to maintain the minimum tension in the wire comprises moving the piston away from the at least one sheave.

25. The method as recited in claim 23, further comprising:
positioning the tubular element to contact the drill string so as to cause a tension of the at least one wire to drop below the preset tension, and, as a response thereto,
moving the piston away from the at least one sheave so as to reestablish/maintain the minimum tension in the at least one wire.

26. The method as recited in claim 23, further comprising:
tensioning the at least one wire with the at least one winch so as to prepare the at least one cylinder unit to carry out a compensation stroke.

27. The method as recited in claim 26, further comprising:
connecting the tubular element to a drill string; and
carrying out the compensation stroke by moving the piston towards the at least one sheave.

28. The method as recited in claim 27, wherein the at least one winch is at rest during the connecting of the tubular element to the drill string.
